(19) United States
(12) Patent Application Publication
(10) Pub. No.: US 2008/0303275 A1
(43) Pub. Date: Dec. 11, 2008

(54) THREADED CONNECTION

(76) Inventor: Orren S. Johnson, Edmonton (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 12/133,341

(22) Filed: Jun. 4, 2008

(30) Foreign Application Priority Data
Jun. 11, 2007 (CA) 2591888

(51) Int. Cl. F16L 25/00

(52) U.S. Cl. 285/334

(57) ABSTRACT

A threaded connection includes an externally threaded pin connection and an internally threaded box connection. The pin connection has a proximate end, a distal end, a pin shoulder at the proximate end and a distal contact surface at the distal end. The box connection has a proximate end, a distal end, an internal contact surface at the proximate end and an external shoulder at the distal end. At least one deformable element is positioned either between the pin shoulder of the pin connection and the external shoulder of the box connection or between the distal contact surface of the pin connection and the internal contact surface of the box connection. The deformable element is of a softer material than that of the pin connection and the box connection, such that the deformable element deforms in response to a momentary torque overload.

### FIELD

The present invention relates to a threaded connection and, in particular, a threaded connection that can withstand momentary torque overload.

### BACKGROUND

In high torque applications, multiple shoulder threaded connections are used. As a general rule, multiple shoulder threaded connections are able to withstand higher torque loading than single shoulder threaded connections. U.S. Pat. No. 4,521,042 is an example of a multiple shoulder threaded connection.

### SUMMARY

There is provided a threaded connection which includes an externally threaded pin connection and an internally threaded box connection. The pin connection has a proximate end, a distal end, a pin shoulder at the proximate end and a distal contact surface at the distal end. The box connection has a proximate end, a distal end, an internal contact surface at the proximate end and an external shoulder at the distal end. At least one deformable element is positioned either between the pin shoulder of the pin connection and the external shoulder of the box connection or between the distal contact surface of the pin connection and the internal contact surface of the box connection. The deformable element is of a softer material than that of the pin connection and the box connection, such that the deformable element deforms in response to a momentary torque overload.

### BRIEF DESCRIPTION OF THE DRAWINGS

These and other features will become more apparent from the following description in which reference is made to the appended drawings, the drawings are for the purpose of illustration only and are not intended to in any way limit the scope of the invention to the particular embodiment or embodiments shown, wherein:

FIG. 1 is a side elevation view, in section, of a preferred embodiment of threaded connection.

FIG. 2 is a side elevation view, in section, of a first alternative embodiment of threaded connection.

FIG. 3 is a side elevation view, in section, of a second alternative embodiment of threaded connection.

FIG. 4 is a side elevation view, in section of a third alternative embodiment of the threaded connection having a tapered thread.

FIGS. 5A, 5B, 5C are detailed side elevation views, in section of a the tapered threads showing the engagement without any deformation, with partial deformation, and with maximum deformation of the deformable elements.

### DETAILED DESCRIPTION

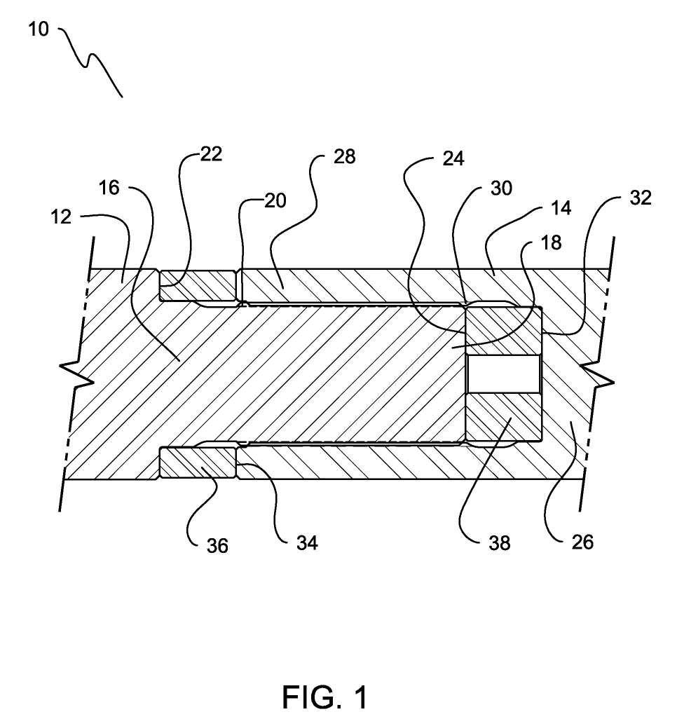

A threaded connection generally identified by reference numeral 10, will now be described with reference to FIG. 1.

### Structure and Relationship of Parts:

Threaded connection 10 includes an externally threaded pin connection 12 and an internally threaded box connection 14. Pin connection 12 has a proximate end 16, a distal end 18, an external thread form 20, a pin shoulder 22 at proximate end 16, and a distal contact surface 24 at distal end 18. Box connection 14 has a proximate end 26, a distal end 28, an internal thread form 30, an internal contact surface 32 at proximate end 26 and an external shoulder 34 at distal end 28. An external deformable element 36 is positioned between pin shoulder 22 of pin connection 12 and external shoulder 34 of box connection 14. An internal deformable element 38 is positioned between distal contact surface 24 of pin connection 12 and internal contact surface 32 of box connection 14. Both of deformable elements 36 and 38 are of a softer material than that of pin connection 12 and box connection 14.

### Operation:

Internal deformable element 38 and external deformable element 36 are placed in position in preparation for connection of pin connection 12 and box connection 14. External thread form 20 of pin connection 12 is then engaged with internal thread form 30 of box connection 14. Upon the threaded connection being engaged, external deformable element 36 ends up positioned between pin shoulder 22 of pin connection 12 and external shoulder 34 of box connection 14; and internal deformable element 38 ends up positioned between distal contact surface 24 of pin connection 12 and internal contact surface 32 of box connection 14. Deformable elements 36 and 38 elastically or plastically deform during the process of making up the connection. This deformation accommodates for variations in length of pin connection 12 and box connection 14 that occurs during manufacturing or as a result of damage. Should a momentary torque overload be encountered, deformable elements 36 and 38 deform in response to a momentary torque overload. Deformable elements 36 and 38 are preferably intended to be “sacrificial” elements that are inspected and periodically replaced.

### Advantages:

There are several advantages provided to the multiple shoulder threaded connection described above:
1) There is not the same precision required in machining, as the deformable elements accommodate a wide range of machining variations.
2) The deformable elements serve to prevent damage to the pin connection, the box connection and other components torsionally coupled to the connection in the event of a momentary torque overload.
3) The deformable elements are inspected and replaced as damage occurs, which prolongs the useful life of the balance of the multiple shoulder threaded connection.

### Variations:

It will be appreciated that the distal contact surface 24 of pin connection 12 and internal contact surface 32 of box connection 14 do not have to be precisely as illustrated. For example, internal deformable element could be positioned between annular shoulders in a manner more closely resembling the manner that external deformable element is retained.

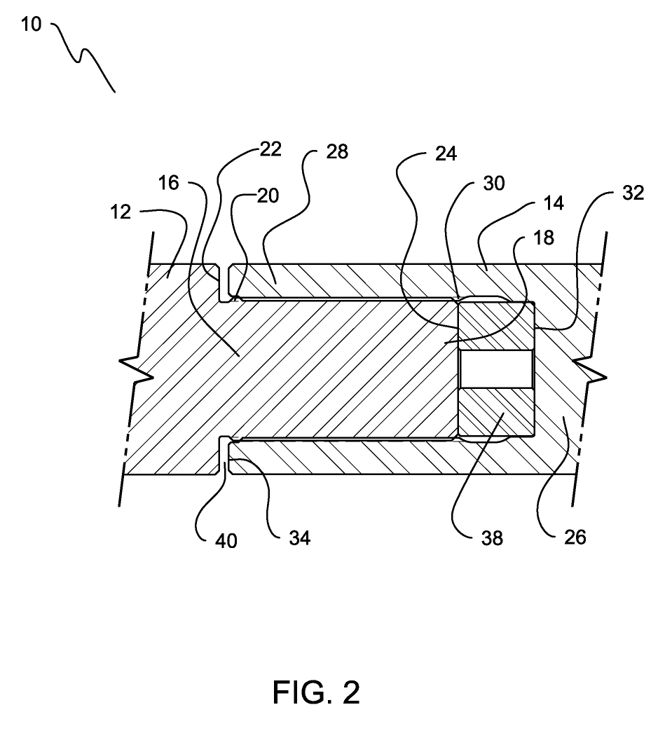

Referring to FIG. 2, a first alternative embodiment is illustrated which functions with only a single deformable element, that element being internal deformable element 38. All of the other components of this threaded connection remain the same and have been identified by the same reference numerals. A gap 40 is left between pin shoulder 22 of pin connection 12 and external shoulder 34 of box connection 14, in this first alternative embodiment so that they do not come into contact with each other. This enables internal deformable element 38 to function as intended without being prevented by engagement of pin shoulder 22 of pin connection 12 and external shoulder 34 of box connection 14.

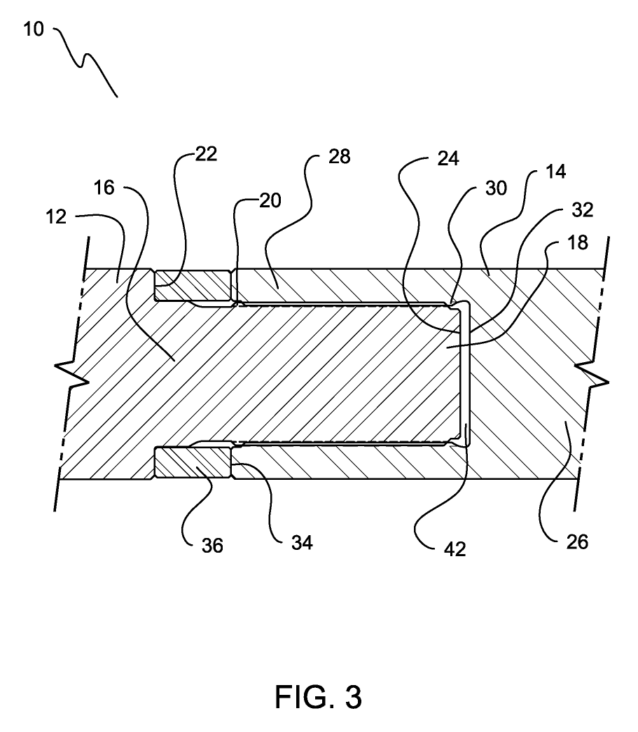

Referring to FIG. 3, a second alternative embodiment is illustrated which functions with only a single deformable element, that element being external deformable element 36. All of the other components of this threaded connection remain the same and have been identified by the same reference numerals. A gap 42 is left between distal contact surface 24 of pin connection 12 and internal contact surface 32 of box connection 14 so that they do not come into contact with each other. This enables external deformable element 36 to function as intended without being prevented by engagement of distal contact surface 24 of pin connection 12 and internal contact surface 32 of box connection 14.

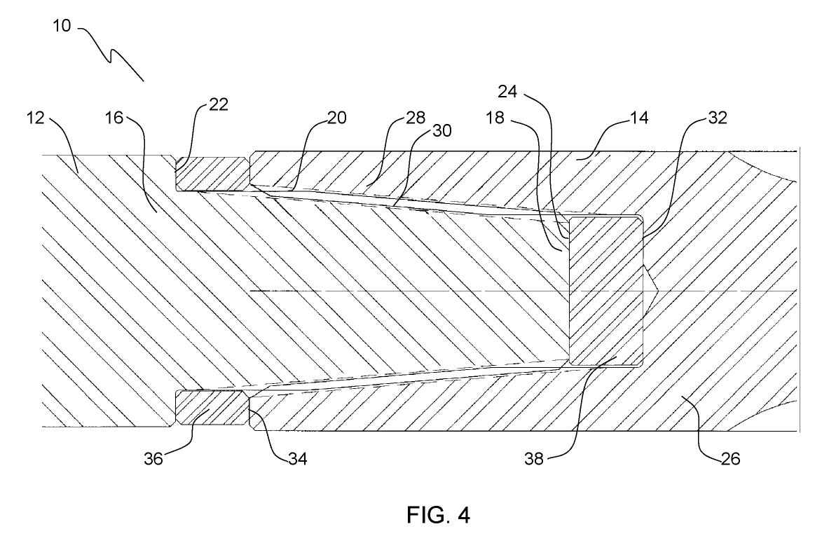

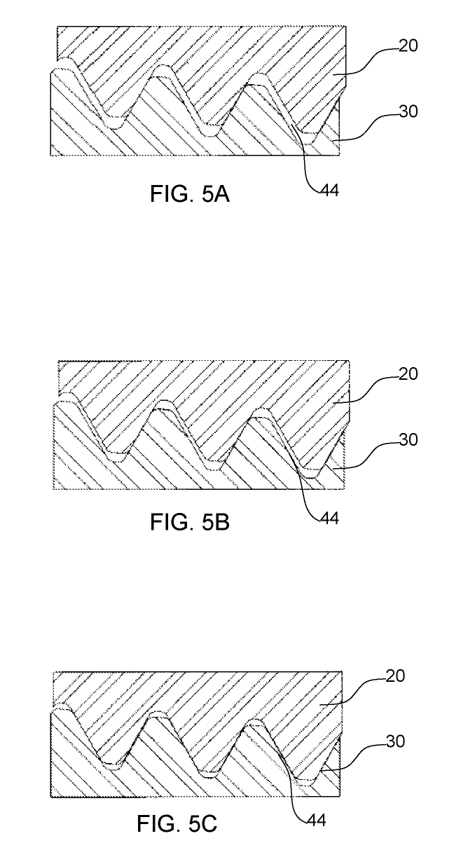

It will also be understood that different threadforms may be used. Referring to FIG. 4, a third embodiment is illustrated that uses tapered threads. However, the use of tapered threads introduces considerations with respect to the clearance of the threads 20 and 30. Referring to FIG. 5A, threads 20 and 30 are shown to be engaged with deformable elements 36 and 38 in a non-deformed state. It will be understood that the variations described in relation to FIGS. 2 and 3 above may also be used in this embodiment. Referring to FIG. 5B, the engagement of threads 20 and 30 is shown with deformable elements 36 and 38 partially deformed, and FIG. 5C shows the engagement of threads 20 and 30 with deformable elements 36 and 38 “fully” deformed. As the deformation progresses, it can be seen that the clearance 44 between the non-load bearing flank of each thread 20 and 30 decreases. Thus, it is necessary to design the clearance in the non-deformed state to allow the desired amount of deformation.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiments without departing from scope of the Claims.

What is claimed is:

1. A threaded connection, comprising:
an externally threaded pin connection having a proximate end, a distal end, a pin shoulder at the proximate end and a distal contact surface at the distal end;
an internally threaded box connection having a proximate end, a distal end, an internal contact surface at the proximate end and an external shoulder at the distal end;
at least one deformable element positioned between the pin shoulder of the pin connection and the external shoulder of the box connection or between the distal contact surface of the pin connection and the internal contact surface of the box connection, the deformable element being of a softer material than that of the pin connection and the box connection, such that the deformable element deforms in response to a momentary torque overload.

2. The threaded connection of claim 1, wherein the deformable element is an external deformable element positioned between the pin shoulder of the pin connection and the external shoulder of the box connection.

3. The threaded connection of claim 1, wherein the deformable element is an internal deformable element positioned between the distal contact surface of the pin connection and the internal contact surface of the box connection.

4. The threaded connection of claim 1, wherein the externally threaded pin connection and the internally threaded box connection are taper threaded.

5. The threaded connection of claim 4, wherein the taper threaded pin connection and box connection have sufficient clearance in the non-deformed state to allow for a desired amount of deformation of the deformable element.

6. A threaded connection, comprising:
an externally threaded pin connection having a proximate end, a distal end, a pin shoulder at the proximate end and a distal contact surface at the distal end;
an internally threaded box connection having a proximate end, a distal end, an internal contact surface at the proximate end and an external shoulder at the distal end;
an external deformable element positioned between the pin shoulder of the pin connection and the external shoulder of the box connection;
an internal deformable element positioned between the distal contact surface of the pin connection and the internal contact surface of the box connection; and
both the external deformable element and the internal deformable element being of a softer material than that of the pin connection and the box connection, such that the external deformable element and the internal deformable element deform in response to a momentary torque overload.

7. A threaded connection, comprising:
an externally taper threaded pin connection having a proximate end, a distal end, a pin shoulder at the proximate end and a distal contact surface at the distal end;
an internally taper threaded box connection having a proximate end, a distal end, an internal contact surface at the proximate end and an external shoulder at the distal end;
at least one deformable element positioned between the pin shoulder of the pin connection and the external shoulder of the box connection or between the distal contact surface of the pin connection and the internal contact surface of the box connection, the deformable element being of a softer material than that of the pin connection and the box connection, such that the deformable element deforms in response to a momentary torque overload, the externally taper threaded pin connection and internally taper threaded box connection having sufficient clearance in the non-deformed state to allow for a desired amount of deformation of the deformable element.
